(19) United States
(12) Patent Application Publication
(10) Pub. No.: US 2010/0322122 A1
(43) Pub. Date: Dec. 23, 2010

(54) BUNDLING OF SPEECH FRAMES IN CS OVER HSPA NETWORKS

(75) Inventors: Per Synnergren, Lulea (SE); Daniel Enstrøm, Gammelstad (SE); Hans Hannu, Lulea (SE)

Correspondence Address: NIXON & VANDERHYE, PC, 901 NORTH GLEBE ROAD, 11TH FLOOR, ARLINGTON, VA, 22203, US

(73) Assignee: TELEFONKTIEBOLAGET LM ERICSSON (PUBL), Stockholm (SE)

(21) Appl. No.: 12/866,415

(22) PCT Filed: Jun. 17, 2008
(86) PCT No.: PCT/SE2008/050722

§ 371 Date: Aug. 5, 2010

Related U.S. Application Data
(60) Provisional application No. 61/026,201, filed on Feb. 5, 2008.

(51) Int. Cl. H04B 7/00; H04L 12/66

(52) U.S. Cl. 370/310; 370/352

(57) ABSTRACT

In a method and mobile station for transmitting speech data over a packet data connection a number of speech data frames are bundled into to a bundled frame, which is transmitted over a packet data connection. Hereby the time when the transmitter needs to transmit can be reduced which in turn will reduce the energy required for transmitting speech data. Hereby the battery life time can be increased. The bundling in accordance with the present invention can advantageously be used when transmitting speech data over a High Speed Packet Access. HSPA. connection.

### TECHNICAL FIELD

The present invention relates to a method and a device for transmitting Circuit Switched (CS) data.

### BACKGROUND

Cellular Circuit Switched (CS) telephony was the first service introduced in the first generation of mobile networks. Since then CS telephony has become the largest service in the world.

Today it is the second generation (2G) Global System for Mobile Communication (GSM) network that dominates the world in terms of installed base. The third generation (3G) networks are slowly increasing in volume, but the early predictions that the 3G networks should start to replace the 2G networks already a few years after introduction and become dominating in sales has proven to be wrong.

There are many reasons for this, mostly related to the costs of the different systems and terminals. But another reason may be that the early 3G networks was unable to provide the end user the performance they needed for IP services like e.g. web surfing and peer-to-peer IP traffic. Another reason may also be the significantly worse battery lifetime of a 3G phone compared to a 2G phone. Some 3G users actually turn of the 3G access, in favor for the 2G access, to save battery.

Later 3G network releases includes High Speed Packet Access (HSPA), HSPA enable the end users to have bit rates that can be compared to bit the rates provided by fixed broadband transport networks like Digital Subscriber Line (DSL). Since the introduction of HSPA. a rapid increase of data traffic has occurred in the 3G networks. This traffic increase is mostly driven by lap-top usage when the 3G telephone acts as a modem. In this case battery consumption is of less interest since the lap-top powers the phone.

After HSPA was introduced. battery consumption became a focus area in the standardization. This lead to the opening of a working item in the 3rd Generation Partnership Project (3GPP) called Continuous Packet Connectivity (CPC). This working item aimed to introduce a mode of operation where the phone could be in an active state but still have reasonably low battery consumption. Such state could for instance give the end-user a low response time when clicking a link in a web page but still give a long stand by time.

The features developed in the CPC working item were successfully included in the 3GPP Release 7 specifications. But, the gain of CPC could only be utilized when running HSPA. This means that battery lifetime increase cannot be achieved for users using the CS telephony service.

In order to be able to increase the talk time of CS telephony another working item has been open that aims to make CS telephony over HSPA possible.

From a high-level perspective a CS over HSPA solution can be depicted as in FIG. 1. An originating mobile station connects via HSPA to the base station NodeB. The base station is connected to a Radio Network Controller (RNC) comprising a jitter buffer. The RNC is via a Mobile Switching Center (MSC)/Media Gateway (MGW) connected to an RNC of the terminating mobile station. The terminating mobile station is connected to its RNC via a local base station (NodeB). The mobile station on the terminating side also comprises a jitter buffer.

In the scenario depicted in FIG. 1, the air interface is using Wideband Code Division Multiple Access (WCDMA) HSPA, which result in that:
The uplink is High Speed Uplink Packet Access (HSUPA) running 2 ms Transmission Time Interval TTI and with Dedicated Physical Control Channel (DPCCH) gating.
The downlink is High Speed Downlink Packet Access (HSDPA) and can utilize Fractional Dedicated Physical Channel (F-DPCH) gating and Shared Control Channel for HS-DSCH (HS-SCCH) less operation, where the abbreviation HS-DSCH stands for High Speed Downlink Shared Channel.
Both uplink and downlink uses Hybrid Automatic Repeat Request (H-ARQ) to enable fast retransmissions of damaged voice packets.

The use of fast retransmissions for robustness, and HSDPA scheduling, requires a jitter buffer to cancel the delay variations that can occur due to the H-ARQ retransmissions, and scheduling delay variations. Two jitter buffers are needed, one at the originating RNC and one in the terminating terminal. The jitter buffers use a time stamp that is created by the originating terminal or the terminating RNC to de-jitter the packets.

The timestamp will be included in the Packet Data Convergence Protocol (PDCP) header of a special PDCP packet type. A PDCP header is depicted in FIG. 2.

The jitter buffer typically needs sequence number information as well to handle reordering. The sequence number used is the RLC sequence number that is passed on to the upper layers.

The CS over HSPA solution that is being standardized in 3GPP R7 and R8 aims to save battery lifetime of the UE. This is achieved by the DTX/DRX functionality of the CPC features DPCCH gating and F-DPCH gating that can be used when running HSPA access. The battery saving is a function of how many transmission time intervals the transmission can be gated. However, it is desired to increase the battery life time even more for transmission of speech data.

Hence there exists a need to increase battery life time and reduce power consumption when transmitting Circuit Switched data such as speech over a packet data connection such as HSPA.

### SUMMARY

It is an object of the present invention to provide a transmission scheme for CS over a packet data connection such as HSPA that reduces power consumption in a mobile station and thereby increase the battery life time.

This object and others are obtained by the method and device as set out in the appended claims. Thus, by bundling a number of speech data frames to a bundled frame, to be transmitted over a packet data connection and then transmitting the bundled frame, the time when the transmitter needs to transmit can be reduced which in turn will reduce the energy required for transmitting speech data. Hereby the battery life time can be increased. The bundling in accordance with the present invention can advantageously be used when transmitting speech data over a High Speed Packet Access, HSPA, connection.

In accordance with one embodiment the number of speech data frames bundled into a bundled frame is set to a default value. Hereby there is no need for additional signaling in the radio network. The default value can for example be set to two speech frames or any other number of frames that is found to be useful for a particular transmission.

In accordance with one embodiment the number of speech data frames bundled into a bundled frame can set dynamically. Hereby the bundling can be controlled to be optimized for a particular connection or even to take into account different transmission conditions during an ongoing connection by changing the number for the ongoing connection. The number of speech data frames bundled into a bundled frame can for example be dynamically set using a Radio Resource Control message.

The invention also extends to a mobile station enabled to transmit speech data in accordance with the above.

The transmission of speech data in accordance with the above will allow a mobile station in a radio system to have longer Discontinuous transmission Discontinuous reception (DTX/DRX) periods, which ultimately leads to a longer battery lifetime of the mobile station.

### BRIEF DESCRIPTION OF THE DRAWINGS

The present invention will now be described in more detail by way of non-limiting examples and with reference to the accompanying drawings, in which:

FIG. 1 is a general view of a system used for packeized voice communication.

FIG. 2 is a view of a Packet Data Convergence Protocol (PDCP) header.

FIG. 3 is a view of illustrating timing of transmission of bundled speech data frames,

FIG. 4 is a view of a system for transmitting bundled speech data, and

FIG. 5 is a flowchart illustrating steps performed in a mobile station when transmitting bundled speech data.

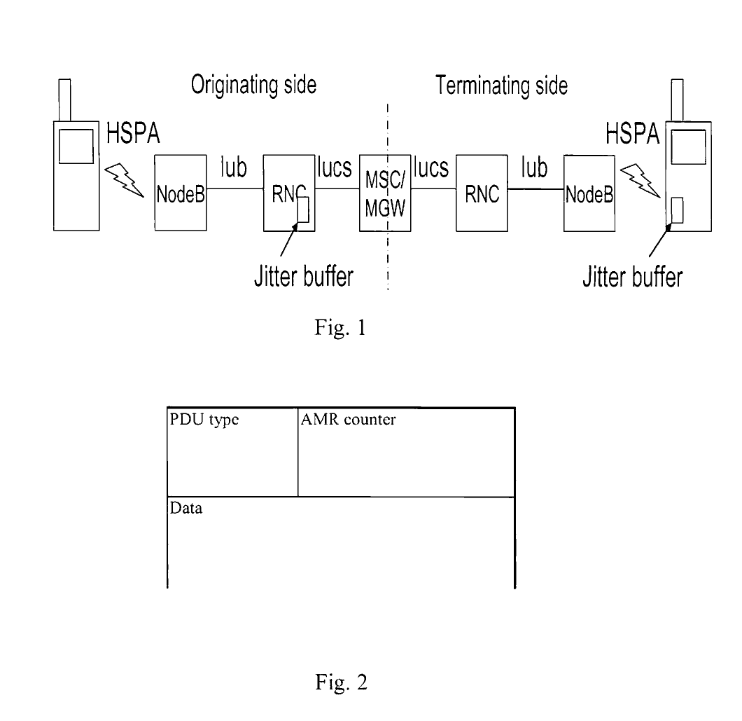

### DETAILED DESCRIPTION

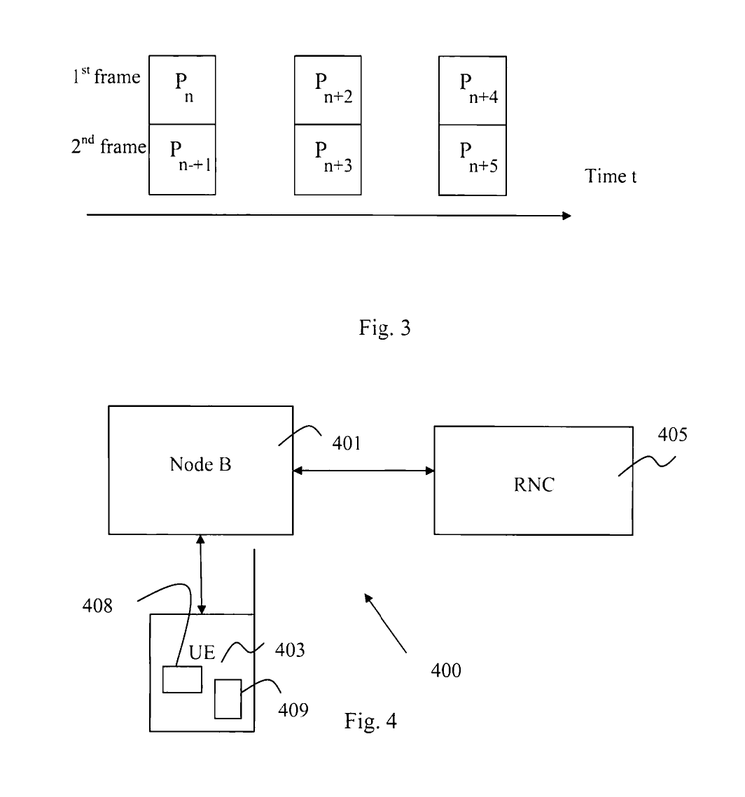

In accordance with the present invention speech frames are bundled. Bundling means that the encoded speech frames are sent in burst rather one-and-one after they have been produced. In FIG. 3 bundling of speech frames is illustrated.

In FIG. 3 the speech frames are bundled in pairs of two so that when two speech frames (Pn) have been generated they are bundled and transmitted as one frame.

In a cellular radio system applying a bursty transmission scheme will be able to reduce battery consumption by bundling speech frames and transmitting the speech data frames in time intervals when the radio transmitter is transmitting. For example in DPCCH/F-DPCH gating, a longer battery lifetime for the mobile stations can be achieved.

The bundling of speech frames will result in a longer time between transmission of speech frames and thus a longer time when there is not transmission, the gating interval, can be achieved. Because battery consumption depends less on the amount of data that is sent at a time: than the time when the radio is transmitting, battery power can be saved by increasing the time interval during which there is no transmission.

Gating allows for Discontinuous transmission/Discontinuous reception (DTX/DRX) of the radio, DTX since there is nothing to send in between the voice frames. DRX is enabled since the transmission can only start after a pre-determined interval. Thus bundling of speech frames results in longer gating intervals when there is no transmission. This in turn can be translated to longer DTX/DRX periods that ultimately save battery.

In transmission of Circuit switched data over a HSPA connection data is transmitted with a PDCP Packet Data Unit (PDU) packet type and an AMR counter field, as is shown in FIG. 2. The AMR counter field can be used to signal the use of bundling. Bundling can also be signaled using a Radio Resource Control message RRC.

In accordance with one embodiment two speech frames can be transmitted in the same transmission in a specific PDCP PDU type. For example a PDCP PDU type indicating the use of bundled data can be defined. The indication is used to inform the jitter buffer that there are two frames to be received in a particular transmission.

In accordance with one exemplary embodiment a PDCP PDU type is used to signal bundling. Below an exemplary embodiment where PDU type 011 is used to indicate bundling.

| Bit | PDCP PDU Type |
|---|---|
| 000 | PDCP Data PDU (Table 7) |
| 001 | PDCP SeqNum PDU (Table 8) |
| 010 | PDCP AMR Data PDU (Table 9) |
| 011 | PDCP Bundled AMR Data PDU |
| 100-111 | Reserved (PDUs with this encoding are invalid for this |
| | version of the protocol) |

A PDCP PDU carrying two AMR frames would look like below for a transmission #X.

| | |
|---|---|
| 011 | AMR counter |

AMR: Speech Frame Pn
AMR: Speech Frame Pn + 1

The AMR counter represents timing information that is synchronized with the AMR speech frame generation rate. The AMR counter will then normally be incremented with 1 every 20 ms. For a PDCP PDU carrying, bundled data the AMR counter value should correspond to the timing when the first voice frame was produced, i.e. when the Pn packet was produced above. The AMR counter is then incremented with the amount of packets it contains to the next transmission. Thus transmission X+1 would in this example look like this:

Transmission #X + 1

| | |
|---|---|
| 011 | AMR counter + 2 |

AMR: Speech Frame Pn + 2
AMR: Speech Frame Pn + 3

However, the stream of speech data can enter a DTX state. If a DTX state is entered no speech codec frames will be generated until the encoders leave the DTX state. When the stream of speech data goes into DTX, a first a SID FIRST frame can be generated, later ordinary SID frames can be generated with an interval of 160 ins. These frames may or may not be bundled. In accordance with one embodiment the SID FIRST or the ordinary SID frames are not bundled because there is a waiting for the first SID frame which is produced 80 ms after the SID FIRST and later 160 ms which is the interval between the SID frames.

In accordance with one embodiment The SID FIRST and the ordinary SID frames can be transmitted as shown below. Transmission Y is a SID FIRST which is packetized as Pn which is sent at time X. This transmission is using an ordinary PDCP AMR DATA PDU (type 010). Later in this example 80 ms later, a SID frame is sent in transmission Y+1. The SID frame is packetized as Pn+1 and the time is X+4, in this example 80 ms later. Again the PDCP PDU type is 010. Then the speech starts again at time X+7, speech is in this example always sent bundled so the PDCP PDU is of type 011.

Transmission #Y

| | |
|---|---|
| 010 | AMR counter value X |

SID FIRST: Frame Pn

Transmission #Y + 1

| | |
|---|---|
| 010 | AMR counter value X + 4 |

SID: Frame Pn + 1

Transmission #Y + 2

| | |
|---|---|
| 011 | AMR counter value X + 7 |

AMR: Speech Frame Pn + 2
AMR: Speech Frame Pn + 3

Two speech frames are sent in the same transmission in the already defined PDCP PDU type 010. In this case a PDCP PDU carrying two AMR frames would look like the example below in transmission #X.

Transmission #X

| | |
|---|---|
| 010 | AMR counter |

AMR: Speech Frame Pn
AMR: Speech Frame Pn + 1

The AMR counter represents timing information that is synchronized with the AMR speech frame generation rate. In normal transmission, the AMR counter is incremented with 1 every 20 ms. For a PDCP PDU carrying bundled data the AMR counter value can be set to correspond to the timing when the first speech data frame is generated, i.e. in this case when the Pn packet is generated. Then the AMR counter is incremented with the amount of packets in the bundled data to the next transmission. The transmission X+1 will then be:

Transmission #X + 1

| | |
|---|---|
| 010 | AMR counter + 2 |

AMR: Speech Frame Pn + 2
AMR: Speech Frame Pn + 3

However, the stream of speech data may go into a DTX state, which means to no speech codec frames will be generated until the encoders leaves the DTX state. When the stream of data packets goes into a DTX state, a SID FIRST frame is generated, thereafter ordinary SID frames are generated with an interval of 160 ms. These frame may or may not be bundled. In accordance with one embodiment the SID FIRST or the SIDs are not bundled because there is then a waiting time for the first SID frame which is generated 80 ms after the SID FIRST and later 160 ms which is the interval between the SIDs.

The SID FIRST and the SIDs can be transmitted in the fashion shown below. Transmission Y is a SID FIRST which is packetized as Pn which is sent at time X. Later on, in this example 80 ms later, a SID frame is sent in transmission Y+1. The SID frame is packetized as Pn+1 and the time is X+4, in this example 80 ms later. Then the speech starts again at time X+7 and the speech is in this exemplary embodiment always transmitted in bundled frames.

Transmission #Y

| | |
|---|---|
| 010 | AMR counter value X |

SID FIRST: Frame Pn

Transmission #Y + 1

| | |
|---|---|
| 010 | AMR counter value X + 4 |

SID: Frame Pn + 1

Transmission #Y + 2

| | |
|---|---|
| 010 | AMR counter value X + 7 |

AMR: Speech Frame Pn + 2
AMR: Speech Frame Pn + 3

In the exemplary embodiment just described it can be noted that the same PDU type is used for both bundled and unbundled PDCP PDUs. In such a case the receiver can use the length of the PDCP PDU to identify whether this packet contain two speech frames or one SID frame.

In accordance with one embodiment the use of bundling and how many frames to be bundled can be signaled by using a Radio Resource Control (RRC) message. In accordance with one embodiment bundling can be restricted to always be for example two AMR frames. In case bundling is restricted to a predetermined number of frames no additional RRC signaling is needed. In cased there is no RRC signaling it is possible to always use a specific PDCP PDU type as described above to signal bundling. Another possibility when no RRC signaling is used is to always check the length of the PDCP PDU.

Furthermore it is to be understood that bundling is not restricted to two frames. Any number of speech frames can be bundled. If the number of frames that are bundled is not a predetermined default number of frames. it is possible to use RRC signaling to inform about the number of bundled speech frames.

In accordance with one embodiment data in a RRC signaling message can be formatted so that the first row is used to signal the support for frame bundling and the second row is the information of how many frames that are bundled. The message can then look like as below:

| CS over HSPA AMR | OP | CS over | REL-8 |
|---|---|---|---|
| bundling information | | HSPA | |
| | | AMR | |
| | | bundling | |
| | | information | |
| | | 10.z.x.ya | |
| >>>AMR frame bundling | MP | Enumerated | Units of AMR frames. |
| | | (1, 2, 3, | |
| | | 4) | |

In accordance with another embodiment UE DTX cycle information used for CPC is used to derive frame bundling information. For example if the UE DTX cycle is set to 16 TTI. the AMR bundling of two or some other predetermined default number of frames is automatically assumed since the UE can only transmit every 32 ms (16*2 ms) and an AMR frame is produced every 20 ms. In such a scenario the setting below for a CS over HSPA radio bearer would indicate speech frame bundling. In accordance with one embodiment a UE_DTX cycle 1 or 2 can be used and if the value is set to 16 or higher, where the range is 1, 4, 8, 16, 32, 64. 128, AMR bundling is activated.

| | | | |
|---|---|---|---|
| >>>UE_DTX cycle 1 | MP | Enumerated =< | Units of gated 2 ms E- |
| (or 2) | | 16 | DCH TTIs. If the DTX |
| | | | time becomes higher than |
| | | | 20 ms the AMR bundling |
| | | | is used. |

In FIG. 4, a general view of a cellular radio system 400 is depicted. The system 400 comprises a base station (Node B) 401. The base station 401 serves a number of mobile terminals, usually termed User Equipment (UE) 403. located within the area covered by the base station 401. The base station 401 and a number of adjacent base stations (not shown) are further connected to a radio network controller node (RNC) 405. The mobile station 401 can connect to the cellular radio system. The system 400 is adapted to transmit Circuit Switched data from the mobile station to an intended receiver for example using CS over HSPA. The mobile station 403 comprises a unit 408 for bundling speech data frames. The mobile station also comprises a transmitter 409 adapted to transmit bundled speech data frames. The unit 408 is adapted to bundle any number of frames into a bundled speech data frame. As set out above, the unit can be set to bundle a default number of frames or any number as signaled as by the radio system.

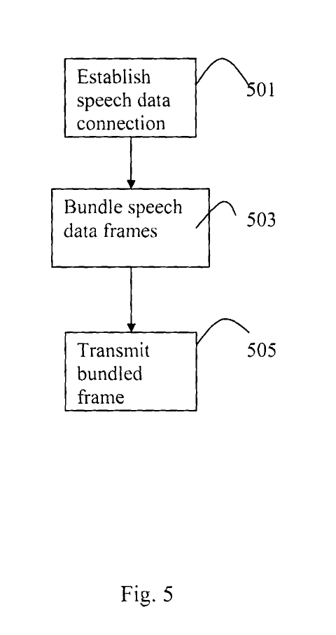

In FIG. 5 a flow chart illustrating steps performed in a mobile station. First in a step 501 a circuit switched speech data connection is established generating speech data frames. Next. in a step 503 the speech data frames are bundled for example as described above. The frames can either be bundled in accordance with a default value of frames or the number of frames bundled can be signaled by the cellular radio system either during set up or later in an already established connection. The number of frames bundled can also be changed at any time during an established connection. The bundled frames are then transmitted in a step 505.

Using the method and mobile station as described herein when transmitting speech data will allow the mobile station in a radio system to have longer Discontinuous transmission Discontinuous reception (DTX/DRX) periods, which ultimately leads to a longer battery lifetime of the mobile station.

1.-16. (canceled)

17. A method of transmitting circuit switched speech data over High Speed Packet Access, HSPA, connection, the method comprising:
initiating a speech data connection generating speech data frames;
bundling a number of speech data frames to a bundled frame,
transmitting the bundled frame.

18. The method according to claim 17, further comprising setting the number of speech data frames bundled into a bundled frame to a default value.

19. The method according to claim 18, further comprising setting the default value to two speech frames.

20. The method according to claim 17, further comprising setting the number of speech data frames bundled into a bundled frame dynamically.

21. The method according to claim 20, further comprising setting the number of speech data frames bundled into a bundled frame dynamically using a Radio Resource Control message.

22. The method according to claim 17, further comprising using a specific Packet Data Convergence Protocol Packed Data Unit, PDCP PDU, type to signal bundling of speech frames.

23. The method according to claim 17, further comprising checking length of a PDCP PDU message to identify a bundled speech frame.

24. A mobile station adapted to transmit circuit switched speech data over a High Speed Packet Access, HSPA, connection via a speech data connection generating speech data frames, the mobile station comprising:
means for bundling a number of speech data frames to a bundled frame,
means for transmitting the bundled frame.

25. The mobile station according to claim 24, further comprising means for bundling a default number of speech data frames bundled into a bundled frame.

26. The mobile station according to claim 25, wherein the default value is two speech frames.

27. The mobile station according to claim 24, further comprising means for bundling a dynamically set number of speech frames into a bundled frame.

28. The mobile station according to claim 27, further comprising means for receiving the number of speech data frames to be bundled into a bundled frame via a Radio Resource Control message.

29. The mobile station according to claim 17, further comprising means for determining the use of bundled speech frame using a specific Packet Data Convergence Protocol Packed Data Unit, PDCP PDU, type.

30. The mobile station according to claim 17, further comprising means for identifying a bundled speech frame by checking the length of a PDCP PDU message.
